(19) United States
(12) Patent Application Publication
(10) Pub. No.: US 2006/0108990 A1
(43) Pub. Date: May 25, 2006

(54) Linearly regulated power supply

(75) Inventors: Chun-Hao Chang, Tu-Cheng (TW); Tong Zhou, Shenzhen (CN); Kun Le, Shenzhen (CN); Jia-Hui Tu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/285,261

(22) Filed: Nov. 21, 2005

(30) Foreign Application Priority Data
Nov. 20, 2004 (CN) 200410052401.8

(51) Int. Cl. G05F 1/56

(52) U.S. Cl. 323/273

(57) ABSTRACT

A linearly regulated power supply is provided for providing a load voltage to a load. In a preferred embodiment, the linearly regulated power supply includes: a voltage divider module for receiving a backup voltage and then providing a voltage reference; a controlling module for receiving the voltage reference and then providing a controlling voltage; and a regulating module receiving the controlling voltage and then regulating a core voltage down to a load voltage, the regulating module providing the load voltage to a load. The linearly regulated power supply is capable of reducing the power of the transistor, and has a higher efficiency.

### CROSS-REFERENCE TO RELATED APPLICATION

Relevant subject matter is disclosed in co-pending U.S. Patent Application entitled “LINEARLY REGULATED POWER SUPPLY”, assigned to the same assignee with this application.

### BACKGROUND OF THE INVENTION

1. Field of the Invention

The present invention relates to regulated power supplies, and particularly to a linearly regulated power supply to provide a regulated voltage to a load mounted on a motherboard.

2. General Background

Linearly regulated power supplies are widely used to supply power to electronic devices, such as to a load on a motherboard of a computer. Such Linearly regulated power supplies are available in a wide variety of configurations for many different applications.

Referring to FIG. 2, a typical linearly regulated power supply providing a 1.2V voltage to chipsets of a motherboard includes a stabilizing voltage module 11, a locking module 13, a controlling module 15 and a regulating module 17.

The stabilizing voltage module 11 includes a capacitance C₁ and a stabilizing voltage chip U₃. The capacitance C₁ is connected to the stabilizing voltage chip U₃ in parallel. The capacitance C₁ and the stabilizing voltage chip U₃ are connected between a ground and a node M. The node M is coupled to a backup power supply via a resistor R₁ to receive a backup voltage V_{sb}. The stabilizing voltage module 11 can stabilize a voltage of the node M.

The locking module 13 includes a transistor Q₁ and a transistor Q₂. An emitter of the transistor Q₁ is grounded. A base of the transistor Q₁ is coupled to a core voltage V_{core} via a resistor R₂. A collector of the transistor Q₁ is coupled to the backup power supply via a resistor R₃ to receive the backup voltage V_{sb}. A base of the transistor Q₂ is connected to the collector of the transistor Q₁. An emitter of the transistor Q₂ is grounded. A collector of the transistor Q₂ is grounded via a resistor R₄. When the core voltage V_{core} is at a high level, the locking module 13 controls the linearly regulated power supply to provide a load voltage Vₒᵤₜ to a load.

The controlling module 15 includes an operational amplifier A₁ and an operational amplifier A₂. The regulating module 17 includes a metal oxide semiconductor field-effect transistor (MOSFET) Q₃ and a MOSFET Q₄. The operational amplifier A₁ is coupled to the stabilizing module 11 and the MOSFET Q₃ in a voltage follower mode. The operational amplifier A₂ is coupled to the locking module 13 and the MOSFET Q₄ in a voltage follower mode. The MOSFET Q₃ is connected to the MOSFET Q₄ in series. The MOSFET Q₃ serves to regulate a system voltage V_{sys} (3.3V) down to a voltage V₁ (2.2V) received by the MOSFET Q₄. The MOSFET Q₄ serves to regulate the voltage V₁ (2.2V) down to an output voltage Vₒᵤₜ (1.2V) needed by the chipsets.

However, the linearly regulated power supply has some disadvantages as follows:

1. Reliability is Low

To presume that a full load current Iₒᵤₜ is 5A, then powers P_{Q3}, P_{Q4} of the two MOSFETs Q₃, Q₄ in a full load circumstance are:
P_{Q3}=U_{Q3}×Iₒᵤₜ=(3.3−2.2)×5=5.5W (1)
P_{Q4}=U_{Q4}×Iₒᵤₜ=(2.2−1.2)×5=5W (2)

The powers P_{Q3}, P_{Q4} shown as the equations (1) and (2) are so high that the MOSFET Q₃, Q₄ is heated easily. The reliability of the linearly regulated power supply is influenced.

2. Efficient is Low

The efficiency η of the linearly regulated power supply is as follow:

$$η = ( \frac{{P}_{out}}{{P}_{in}} ) ⨯ 100 \% = ( \frac{{U}_{out} ⨯ {I}_{out}}{{U}_{in} ⨯ {I}_{out}} ) ⨯ 100 \% = \frac{{V}_{out}}{{V}_{sys}} ⨯ 100 \% = \frac{1.2}{3.3} ⨯ 100 \% \approx 36.4 \% \qquad ( 3 )$$

What is needed, therefore, is a linearly regulated power supply which has a higher reliability and a higher efficiency.

### SUMMARY

A linearly regulated power supply is provided for providing a load voltage to a load. In a preferred embodiment, the linearly regulated power supply includes: a voltage divider module for receiving a backup voltage and then providing a voltage reference; a controlling module for receiving the voltage reference and then providing a controlling voltage; and a regulating module receiving the controlling voltage and then regulating a core voltage down to a load voltage. The regulating module provides the load voltage to the load.

The linearly regulated power supply is capable of reducing the power of the transistor, and has a higher efficiency.

Other advantages and novel features will become more apparent from the following detailed description of preferred embodiments when taken in conjunction with the accompanying drawings, in which:

### BRIEF DESCRIPTION OF THE DRAWINGS

FIG. 1 is a circuit diagram of a linearly regulated power supply of a preferred embodiment of the present invention; and

FIG. 2 is a circuit diagram of a typical linearly regulated power supply.

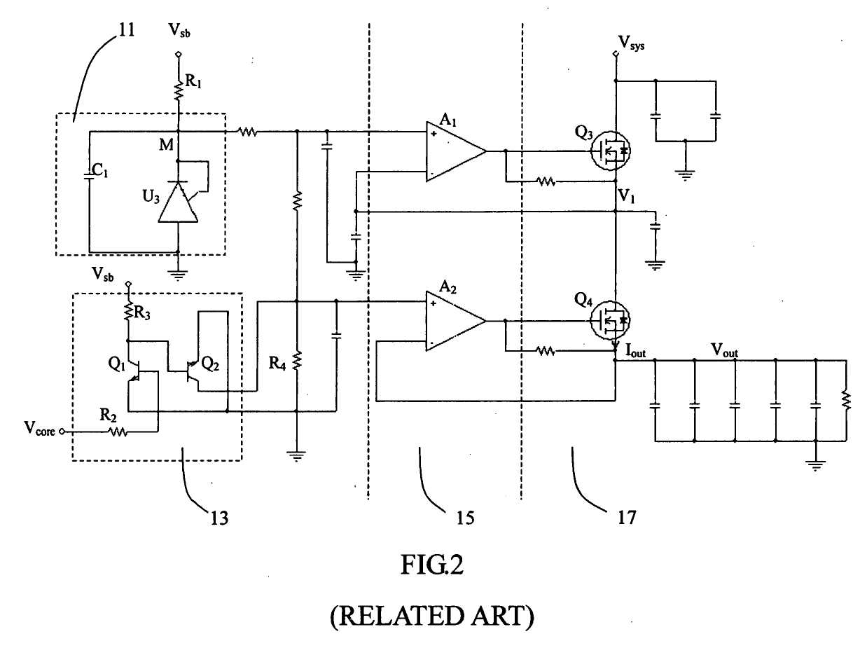

### DETAILED DESCRIPTION OF THE EMBODIMENTS

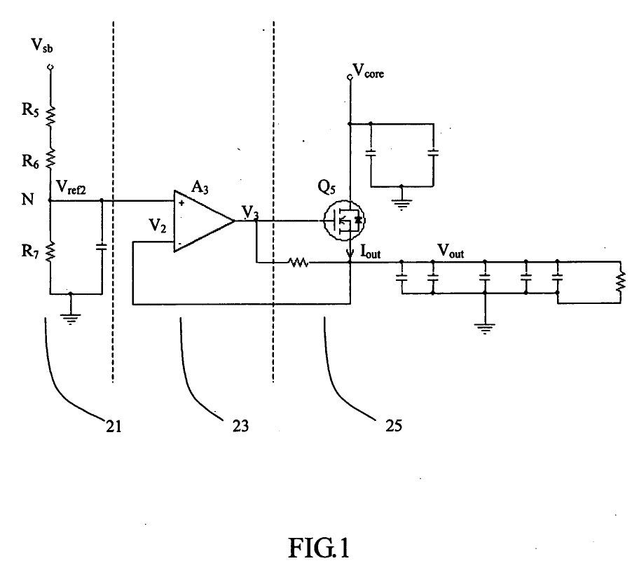

As shown in FIG. 1, in one embodiment of the present invention, a linearly regulated power supply includes a voltage divider module 21, a controlling module 23, and a regulating module 25.

The voltage divider module 21 includes a resistor R₅, a resistor R₆ and a resistor R₇ connected to one another in series. The voltage divider 21 is connected between a backup power supply and ground. A backup voltage V_{sb} provided by the backup power supply is divided into a voltage reference V_{ref2} by the voltage divider module 21. A node N between the resistor R₆ and the resistor R₇ provides the voltage reference V_{ref2} to the controlling module 23. The controlling module 23 includes an operational amplifier A₃ for controlling the regulating module 25. The regulating module 25 includes a MOSFET Q₅ for regulating a core voltage V_{core} down to a load voltage Vₒᵤₜ. The operational amplifier A₃ is coupled to the voltage module 21 and the MOSFET Q₅ in a voltage follower mode. A non-inverting input terminal of the operational amplifier A₃ is connected to the node N for receiving the voltage reference V_{ref2}. An inverting input terminal of the operational amplifier A₃ is connected to a source of the MOSFET Q₅ for receiving a feedback voltage V₂. The output terminal of the operational amplifier A₃ is connected to a gate of the MOSFET Q₅ for supplying a controlling voltage V₃ to the gate of the MOSFET Q₅. A drain of the MOSFET Q₅ receives the core voltage V_{core} (1.5V). The source of the MOSFET Q₅ provides the load voltage Vₒᵤₜ (1.2V) to a load.

When the load voltage Vout suddenly becomes higher, the feedback voltage V₂ becomes higher too. The controlling voltage V₃ becomes lower correspondingly. Then a voltage V_{GS} (not shown in FIG. 1) between the gate and the source of the MOSFET Q₅ becomes lower. The decrease of the voltage V_{GS} induces a reduction of an output current Iₒᵤₜ. Therefore the load voltage Vₒᵤₜ drops to a same level as before the sudden increase thereof.

Contrarily, when the load voltage Vout suddenly becomes lower, the feedback voltage V₂ becomes lower too. The controlling voltage V₃ becomes higher correspondingly. Then the voltage U_{GS} between the gate and the source of the MOSFET Q₅ becomes higher. The increase of the voltage U_{GS} induces an enhancing of the output current Iₒᵤₜ. Therefore the load voltage Vₒᵤₜ climbs to a same level as before the sudden decrease thereof.

In the illustrated embodiment, the controlling module 23 controls the regulating module 25 to provide the load voltage Vₒᵤₜ to be at the same level as the voltage reference V_{ref2}. Providing the voltage reference V_{ref2} is 1.2V, the load voltage Vₒᵤₜ is 1.2V. The core voltage V_{core} usually is 1.5V. Providing in the full load circumstance the output current Iₒᵤₜ is 5A, power of the MOSFET Q₅ is:
P_{Q5}=U_{Q5}×Iₒᵤₜ=(1.5−1.2)×5=1.5W (4)
Efficiency η in the full load circumstance is:

$$η = ( \frac{{P}_{out}}{{P}_{in}} ) ⨯ 100 \% = ( \frac{{V}_{out} ⨯ {I}_{out}}{{V}_{in} ⨯ {I}_{out}} ) ⨯ 100 \% = \frac{1.2}{1.5} ⨯ 100 \% \approx 80 \% \qquad ( 5 )$$

Shown as the equations (4) and (5), the power of the present invention is lower than that of the typical linearly regulated power supply, and the efficiency is higher than that of the typical linearly regulated power supply.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A linearly regulated power supply comprising:
a voltage divider module capable of accepting a backup voltage and providing a voltage reference;
a controlling module capable of accepting the voltage reference and providing a controlling voltage; and
a regulating module capable of receiving the controlling voltage and regulating a core voltage down to a load voltage according to the controlling voltage so as to provide the load voltage to a load.

2. The linearly regulated power supply as claimed in claim 1, wherein the voltage divider module comprises two resistors connected to each other in series, and a node between the resistors for providing the voltage reference to the controlling module.

3. The linearly regulated power supply as claimed in claim 1, wherein the controlling module comprises an operational amplifier, the operational amplifier includes a non-inverting input terminal connected to the voltage divider module for receiving the voltage reference, an inverting input terminal connected to the regulating module for receiving a feedback voltage, and an output terminal connected to the regulating module for controlling the regulating module.

4. The linearly regulated power supply as claimed in claim 1, wherein the regulating module includes a MOSFET (metal-oxide-semiconductor field-effect transistor), a gate of the MOSFET is controlled by the controlling module, a drain of the MOSFET receives the backup voltage, and a source of the MOSFET provides the load voltage to the load.

5. The linearly regulated power supply as claimed in claim 1, wherein the backup voltage is 3.3V.

6. The linearly regulated power supply as claimed in claim 1, wherein the core voltage is 1.5V.

7. The linearly regulated power supply as claimed in claim 1, wherein the load voltage is 1.2V.

8. A linearly regulated power supply comprising:
a plurality of resistors connected to each other in series, the resistors receiving a backup voltage and then providing a voltage reference;
an operational amplifier for receiving the voltage reference and then providing a controlling voltage; and
a MOSFET (metal-oxide-semiconductor field-effect transistor) receiving the controlling voltage and then regulating a core voltage down to a load voltage, the regulating module providing the load voltage to a load.

9. The linearly regulated power supply as claimed in claim 8, wherein the operational amplifier includes a non-inverting input terminal connected to the resistors for receiving the voltage reference, an inverting input terminal connected to the MOSFET for receiving a feedback voltage, and an output terminal connected to the MOSFET for controlling the MOSFET.

10. The linearly regulated power supply as claimed in claim 8, wherein a gate of the MOSFET is controlled by the operational amplifier, a drain of the MOSFET receives the backup voltage, and a source of the MOSFET provides the load voltage to the load.

11. The linearly regulated power supply as claimed in claim 8, wherein the backup voltage is 3.3V.

12. The linearly regulated power supply as claimed in claim 8, wherein the core voltage is 1.5V.

13. The linearly regulated power supply as claimed in claim 8, wherein the load voltage is 1.2V.
